(19) United States
(12) Patent Application Publication
(10) Pub. No.: US 2010/0227930 A1
(43) Pub. Date: Sep. 9, 2010

(54) ECOLOGICAL QUATERNARY AMMONIUM DISINFECTANT CLEANER

(76) Inventor: Normand LUSIGNAN, Mirabel (CA)

Correspondence Address: CHOATE, HALL & STEWART LLP, TWO INTERNATIONAL PLACE, BOSTON, MA, 02110, US

(21) Appl. No.: 12/604,596

(22) Filed: Oct. 23, 2009

Related U.S. Application Data
(60) Provisional application No. 61/157,948, filed on Mar. 6, 2009.

(51) Int. Cl. A01N 33/12; A01P 1/00

(52) U.S. Cl. 514/642

(57) ABSTRACT

The present invention concerns an ecological benzineless quaternary ammonium disinfectant cleaner comprising quaternary ammonium compound(s) either (i) including octyl decyl dimethyl ammonium chloride, dioctyl dimethyl ammonium chloride and didecyl dimethyl ammonium chloride, in a relative proportion of about 2:1:1 by weight, or (ii) consisting essentially of quaternary ammonium compounds consisting essentially of didecyl dimethyl ammonium chloride; the disinfectant cleaner also comprising a sequesterant such as polycarboxylates and diamines and combinations thereof; a surfactant; a builder such as silicates, carbonates and citrates and combinations thereof; and preferably a solvent such as glycol ether series. This disinfectant cleaner enables improved properties regarding ASTM D4488-95-A5, mammalian acute toxicity orally and dermally; aquatic acute toxicity for Daphnia Magna; higher water hardness tolerance; improved adherence to vertical and horizontal surfaces and it meets the stringent requirements of the Ecologo™ CCD-166 certification.

### CROSS-REFERENCE TO RELATED APPLICATION

This application claims priority to U.S. provisional patent application Ser. No. 61/157,948, filed Mar. 6, 2009, the entire contents of which is incorporated herein by reference.

### FIELD OF THE INVENTION

The present invention generally relates to the field of disinfectant cleaners and more particularly to an ecological quaternary ammonium disinfectant cleaner.

### BACKGROUND

Ecological products are gaining ground both in terms of regulatory and consumer requirements. For instance, Environmental Choice Program™ of Canada has published certification criteria documentation in various fields including disinfectants and disinfectant-cleaners referred to as CCD-166. Other marketing and regulatory agencies and institutions such as Terrachoice Environment Marketing, Cleangredients and DFE also set out various criteria to guide the production, formulation and use of disinfectant cleaners. Very few disinfectant cleaners are able to meet these stringent criteria.

The following is an overview of some patent literature regarding disinfectants that are not able to meet the CCD-166 standards.

Canadian Patent No. 2,052,160 (Peters) discloses a cleaner disinfectant based on quaternary ammonium compounds but also teaches the use of ethylene diamine tetraacetic acid at 3% by weight. This chelating agent is disallowed according to CCD-166.

Canadian Patent No. 2,620,175 (Quick-Med Technologies) also teaches the use of quaternary ammonium compounds as a disinfectant cleaner but it contains dyes “fluorescin” and/or benzalkonium, which are disallowed according to CCD-166. Furthermore, any derived urethane component will not conform to the general components policy of Terrachoice Environment Marketing.

Canadian Patent No. 2,358,703 (S.C. Johnson Commercial Market) teaches the use of quaternary ammonium salts including didecyl dimethyl ammonium chloride in is cleaner disinfectant, however they also teach the addition of ethylene diamine tetraacetic acid, nitrilotriacetic acid, tetrasodium ethylene diamine tetraacetic acid or mixtures thereof, which are all prohibited ingredients according to CCD-166.

Canadian Patents No. 2,173,435 (Proctor & Gamble Company) describes a quaternary ammonium disinfectant and selected dicarboxylate sequestrants. There is also used a dual quaternary ammonium made of alkyl dimethyl benzyl ammonium chloride and ethylbenzyl ammonium chloride, which are prohibited according to CCD-166. Benzene molecules are also prohibited by Terrachoice Enviromental Marketing's guidelines. Preferred quaternary ammonium disinfectants are N′ Alkyl (C₁₂-C₁₈) benzyl dimethyl ammonium chloride and N′ Alkyl (C₁₂-C₁₈) dimethyl ethylbenzyl ammonium chloride and di-n-alkyl (C₈-C₁₀) dimethyl ammonium chloride.

Canadian Patent No. 1,323,298 (Ecolab) discloses a disinfectant coating for hard surfaces and the use of quaternary ammonium compound as disinfectant cleaner. However, the disinfectant component quaternary salt is preferably C₁₀-C₂₀-n-alkyl (dimethyl)benzyl ammonium salt which is prohibited according to CCD-166.

Canadian Patent No. 2,315,760 (Air Liquid Sante) teaches the use of didecyl dimethyl ammonium chloride in admixture with n,n′-substituted glycine and n,n′-substituted derivatives sold as Amphionic SFB by Rhone Poulenc. However, this composition needs the addition of chelating agents and ethylene diamine tetraacetic acid or nitrilotriacetic acid or their salts, which are prohibited by CCD-166. This patent also suggests the use of alkylbenzyl dimethyl ammonium chloride, a prohibited compound. Also, some examples of the compositions contain high levels of DDAC that will not meet CCD-166 standards, in particular the toxicity on luminescent bacteria, (EPS 1/RM/24 of Environment of Canada) acute oral toxicity of >2,000 mg/kg OECD test method 420.

Until today, only two disinfectant cleaners have been certified under CCD-166 by Terrachoice Environmental Marketing: one is based on hydrogen peroxide, an almost odorless component, free of toxic vapours but sensitive to heat, requiring distilled water as a solvent to be stable, restricted choice of surfactants and requires special blending equipment, storage and transport caution.

The second product includes a quaternary ammonium mixture including a) Octyl Decyl Dimethyl ammonium chloride 50% by weight, b) Didecyl Dimethyl ammonium chloride 30% by weight and c) Dioctyl Dimethyl ammonium chloride 20% by weight, for a proportion of 5:3:2. This mixture made by Lonza™ (90 Baroline Road, Allendale, N.J., USA) and is sold under the trademark BARDAC™ 2050 for the 50% solution and BARDAC™ 2080 for the 80% solution. A disinfectant cleaner has been made using this mixture of quaternary ammonium compounds and contains 4.8% solution by weight of BARDAC™ 2080 on 100% basis and is sold in Canada by Dustbane Products Limited™, 25 Pickering Road, Ottawa, Ontario, Canada under the name of Quat-Plus™. The DL₅₀ orally for BARDAC™ 2050 or 2080 is 455 mg/kg at is lowest toxicity level and the dermal toxicity at is lowest level is 650 mg/kg for mammalian acute toxicity. The EC₅₀ for Daphnia magna is 0.058 mg/l—this information is from the MSDS provided by Lonza™ inc., the manufacturer of BARDAC™ 2050 and 2080 page 4 of the 6 pages section IX, Toxicology Information MSDS # 95323 of Lonza™. Quat-Plus™ products are limited to 600 ppm of hard water tolerance.

There is a need for improved disinfectant cleaners that offer improved properties over what is already known and can meet the CCD-166 criteria.

### SUMMARY OF THE INVENTION

The present invention responds to the above need by providing an ecological quaternary ammonium disinfectant cleaner.

More particularly, in one aspect of the invention, there is provided a benzeneless quaternary ammonium disinfectant cleaner comprising quaternary ammonium compounds either comprising (i) octyl decyl dimethyl ammonium chloride, dioctyl dimethyl ammonium chloride and didecyl dimethyl ammonium chloride, in a relative proportion of about 2:1:1 by weight or (ii) consisting essentially of didecyl dimethyl ammonium chloride. The disinfectant cleaner also comprises a sequesterant chosen from polycarboxylates, silicates, carbonates, citrates and diamines and combinations thereof; a surfactant; and a builder chosen from silicates, carbonates and citrates and combinations thereof.

The disinfectant cleaner of the present invention enables improved ASTM D4488-95-A5 performance, toxicity properties, in particular with regard to mammalian acute toxicity orally and dermally and with regard to aquatic acute toxicity for Daphnia Magna, for example. The disinfectant cleaner of the present invention further enables higher water hardness tolerance. The disinfectant cleaner also meets the stringent requirements of the Ecologo™ CCD-166 certification. Embodiments of the disinfectant cleaner provide adherence to vertical and horizontal hard surfaces which improve soils penetration and contact for disinfection.

### DETAILED DESCRIPTION OF THE PREFERRED EMBODIMENTS

The preferred embodiments of the disinfectant cleaner of the present invention will be described below. The disinfectant cleaners allow improvements in ASTM D4488-95-A5 performance, water hardness tolerance, mammalian toxicity, and aquatic toxicity especially for the invertebrate the Daphnia Magna, and various embodiments also have improved tackiness and meet various ecological guidelines.

In a first aspect of the invention, the benzineless quaternary ammonium disinfectant cleaner comprises quaternary ammonium compounds including octyl decyl dimethyl ammonium chloride, dioctyl dimethyl ammonium chloride and didecyl dimethyl ammonium chloride, in a relative proportion of about 2:1:1 by weight. In a second aspect of the invention, the benzineless quaternary ammonium disinfectant cleaner comprises quaternary ammonium compounds consisting essentially of didecyl dimethyl ammonium chloride. These proportions enable improved toxicity and hard water tolerance properties, for instance.

The first and second aspects of the disinfectant cleaner also include a sequesterant chosen from polycarboxylates and diamines and combinations thereof; a surfactant; a builder chosen from silicates, carbonates and citrates and combinations thereof; and a solvent chosen from glycol ethers and mixtures of thereof.

Each of the components of the disinfectant cleaner will be further discussed below.

### Active Disinfectant Component

In one preferred aspect of the disinfectant cleaner, the active disinfecting agent is a mixture of quaternary ammonium compounds including octyl decyl dimethyl ammonium chloride, dioctyl dimethyl ammonium chloride and didecyl dimethyl ammonium chloride, in a relative proportion of about 2:1:1 by weight. Preferably, this mixture consists essentially of these three quaternary ammonium compounds. Such a mixture may correspond to one manufactured by Stepan™ as BTC 818™, or to one manufactured by Mason Chemicals™ as Maquat (40-50%).

The BTC 818™ mixture has a mammalian acute toxicity orally (DL₅₀) of 500 mg/kg and dermally of 2,000 mg/kg. Based on the fact that a disinfectant cleaner meeting the criteria of CCD-166 must comply with Canadian CGSB-2.161-97 (Assessment of Efficacy of Anti-Microbial Agents for use on Environmental surfaces and Medical Devices), the use of dilution for testing the disinfectant cleaner will be 1-80 parts of water. The 45 mg difference between BARDAC™ 2050-2080 and the BTC™ 818 50% or 80% solutions will result in significant improvement of oral acute toxicity (3,600 mg/kg).

Also, the dermal acute toxicity of BARDAC™ 2050 or 2080 is 316 to 650 mg/kg and it is 3 to 6.3 times more toxic then BTC 818™ 50 or 80% solution, which has a DL₅₀ of 2,000 mg/kg. At a dilution of 1-80 parts of water, the acute dermal toxicity of BTC™ 818 represents a significant improvement over BARDAC™ 2050-2080-based Quat-Plus™ compositions. Aquatic acute toxicity properties for Daphnia magna is another improvement of the disinfectant cleaner of the invention. Quat-Plus™ gives an EC₅₀ of 0.058 mg/l., for 48 hours of exposure, while embodiments of the disinfectant cleaner of the present invention display 0.094 mg/l for EC₅₀ on Daphnia Magna, which represents 61% less toxicity for 48 hours of exposure.

In another preferred embodiment of the disinfectant cleaner, the active disinfecting agent is didecyl dimethyl ammonium chloride. Such a compound may correspond to ones sold as BTC 1010™, BTC1010™ 80%, BTC 99™, Maquat 4450-E™ or Maquat 4480E™. Such disinfectant agents are tolerant to hard water up to 1200 ppm, however they have poorer water solubility than the above-mentioned blend of three quaternary ammonium compounds in the relative proportions of 2:1:1. Didecyl dimethyl ammonium chlorides are nevertheless ingredients to be considered in the ecological disinfectant of the present invention at least in part because of their eco-toxicological profile, which is similar to that of BTC 818™, their effectiveness as a disinfectant agent and their hard water tolerance.

The quaternary ammonium compounds as used in embodiments of the present invention enable exception and unexpected degreasing performance.

The quaternary ammonium compounds as used in the present invention, that is (i) octyl decyl dimethyl ammonium chloride, dioctyl dimethyl ammonium chloride and didecyl dimethyl ammonium chloride, in a relative proportion of about 2:1:1 by weight, and (ii) essentially didecyl dimethyl ammonium chloride, also have criticality in terms of the technical limits of manufacture of quaternary ammonium compounds.

### Cleaning Agents, Co-Surfactants and Inert Ingredients

Categories of these ingredients are the non ionic and the amphoteric surfactants, builders, essential oils, fragrances and emollients. They are chosen from ingredients accepted for disinfectants by Health Canada or the Environmental Protection Agency (EPA) in of the United States. They can be active or non active ingredients.

In one preferred embodiment of the disinfectant cleaner, the ingredients are ones which are also on the list of accepted ingredients of an ecological organisation such as Terrachoice Environmental Marketing, Cleangredients or DFE (Design for Environment), an ecological organisation which works closely with the EPA. The EPA and Health Canada are each the sole agency legally authorized for delivery, evaluation and/or issuance of disinfectants for the United States and Canada respectively.

### Non-Ionic Surfactants

### Ethoxylated Alcohols

In one preferred embodiment of the disinfectant cleaner, non-ionic surfactants are used. Such non-ionic surfactants are the linear ethoxylated fatty alcohols like the Biosoft™ line sold by Stepan™, for example Biosoft™ N91-2.5 alcohol chain length C₉ C₁₀ C₁₁ with average moles of ethoxylation of 2.5, Biosoft™ N91-6 C₉ C₁₀ C₁₁ with average moles of ethoxylation of 6, Biosoft™ N91-8 C₉ C₁₀ C₁₁ with average moles of ethoxylation of 8, Biosoft™ NI-3, Biosoft NI-5, Biosoft™ NI-7, Biosoft™ NI-9 all having an alcohol chain length of C₁₁ with respective average moles of ethoxylation of 3,5,7 and 9, Biosoft™ N 23-3 and Biosoft™ N 23-6.5 both having an alcohol chain length of C₁₂ C₁₃ with respective average moles ethoxylation of 3 and 6.5, Biosoft™ 25-3, Biosoft™ 25-7, Biosoft™ 25-9, Biosoft™ 25-12 all having alcohol chain length of C₁₂ C₁₃ C₁₄ C₁₅ with respective average mole of ethoxylation of 3,7,9,12.

Tomadol™ 45-7, 45-13 Poly (7) or (13) having an alcohol chain length of C₁₄ C₁₅ and average moles of ethoxylation of 7 and 13, which is sold by Tomah Products™ Milton, Wis., USA, may also be used.

Other preferred non-ionic surfactants are alcohol ethoxylate sold as Lutensol XP™ of BASF™ Corporation, 3000 Continental DR-North Mount Olive, N.J., USA. Such surfactants have good eco-toxicity profile. They meet the 10 days window level of biodegradation, they have an excellent aquatic acute toxicity for invertebrate Daphnia Magna with and EC₅₀ (48H) of 10-100 mg/l plus an EC₅₀ (72H) of 10-100 mg/l for green algae. Lutensol XP™ 40, 50, 60, 69, 70, 79, 80, 90, 99 also appear on the Cleangredients list and have passed the screening test of the DFE. Another preferred alcohol ethoxylate is Videt™ Q3 from Vitech International™, P.O. Box 7, Milton, Wis., USA. This product possess impressive interfacial low tension with a good ecological profile especially for aquatic acute toxicity, which is 70.7 mg/l for rainbow trout, it is also a surfactant listed on the Cleangredients list and meet the 10 days window for ready biodegradation and has passed the DFE screening test.

In another preferred embodiment, the alcohol ethoxylates are Biosoft™ 91-8 91-6, NI-5, EC690 Videt™ Q3, and/or Lutensol™ XP79, 89, 99, due to their cleaning performance, ecological profile, their meeting the 10 days window for ready biodegradation, passing the DFE screening test and their appearance on the Cleangredients list.

### Alkyl Polyglucosides

Alkyl polyglucosides are also preferred useful non-ionic surfactants that may be used in the disinfectant cleaners of the present invention. C₁₂ C₁₋₄ alkyl polysaccharide ether sucrose and glucose esters derivatives, C₈ C₁₀ alkyl polysaccharide ether, C₈ C₁₋₆ alkyl polysaccharide ether sucrose and glucose esters derivatives and C₈ C₁₋₄ alkyl polysaccharide ether. They are sold by Cognis™, Cincinnati, Ohio, USA. Some of these alkyl polyglucosides are marketed as Glucopon™ 50G, 215UP, 225DK, 425N/Nh, 600 CS UP, 650EC, in European countries and are marketed in North America as Glucopon™ APG 325N, 215UP, 225DK, 425N, 600UP and 625UP. They all figure on the list of Cleangredients, meet the 10 days window for ready biodegradation, have good aquatic and mammalian toxicity and they have passed the DFE screening test. Glucopon alkyl polyglucoside is also well known for its very low skin irritancy. It often improves the performance of other surfactants and reduce their skin irritancy. Preferred are Glucopon™ 215UP, 225DK, 625UP and 425N.

### Alkanolamide

Alkanolamides are other preferred useful surfactants. They can be lauric, coconut, soya rapeseed, oleic or mixture of thereof. Preferred are lauric diethanolamine with the cas # 120-40-1, examples of which are Ninol™ 30LL and Ninol™ 55LL from Stepan™, Northfield, Ill., USA.

### Amine Oxides

Other preferred non-ionic surfactants are amine oxide lauryl, myristyl, coco or mixture of thereof and most preferred being cocoamidopropyl amine oxide especially for their ecological profile and cleaning performance. Examples of these are Macat ultra CDO™ from Mason Chemicals™, 721 West Algonquin Road, Arlington Heights, Ill., USA. This amine oxide appears on the list of Cleangredients, meets the 10 days window for ready biodegradation, show aquatic toxicity of 10-100 mg/l and have passed the screen test of the DFE.

### Amphoteric

Other preferred surfactants are amphoteric surfactants such as amidopropyl betaine, alkyl amine oxide and amphoteric sultaine. Most preferred are amphoteric sultaines which are particularly effective in soap scum removal and the one with cas # 72869-77-3 showing good ecological properties and appearing on Cleangredients list. They pass the 10 days window for ready biodegradation, show an acute aquatic toxicity of 10-100 mg/l and pass the DFE screening test.

### Sequestrants

The disinfectant cleaner of the present invention also comprises a sequesterant chosen from polycarboxylates and diamines and combinations thereof. Sequestrants improve the functioning and performance of the disinfectant agents by sequestering positively charged calcium and magnesium ions, which compete with the quaternary ammonium compound(s) for the negatively charged bonding sites on the bacteria. The addition of sequestrants, which bond themselves with calcium and magnesium, frees the reactive sites on the micro-organisms to form complexes with the quaternary ammonium compound(s) of the disinfectant cleaner. These sequestrants are preferably organic and readily biodegradable with low aquatic and mammalian toxicity. Preferred sequestrants are citrate, gluconate, tartaric, adipic, iminodisuccinate (IDS), ethylene diamine disuccinate (EDDS), glutamic acid and its salts, and methyl glycinate for instance sold as Trilon M™ sold by BASF Corporation. These sequestrants are not only effective in sequestering and improving hard water tolerance, but they can also impart tackiness to the disinfectant cleaner for additional advantageous functionality without increasing viscosity (citrate and gluconate particularly). This will permit the disinfectant cleaner to penetrate surfaces deeply and adhere to vertical ones, providing even coating and a longer contact time. Tartaric will be particularly good at reducing filming and streaking. Ethylene diamine disuccinate (EDDS) will be preferred amongst these sequestrants if water hardness in general is the main target property to improve. Some preferred sequestrants are Tetrasodium iminodisuccinate sold as Baypure™ by Lanxess Corporation™, 111 Ridc Park West Drive, Pittsburgh, Pa., USA. The iminodisuccinate tetrasodium salt (IDS) is less effective than ethylene diamine disuccinate (EDDS) and methyl glycinate (Trilon M™) as chelating agents but IDS is more available and less expensive. When choosing the most preferred ecological chelating agent, one should preferably consider availability, efficacy, biodegradation, aquatic and mammalian toxicity. The DL₅₀ oral rat acute toxicity is over 2,000 mg/kg, acute aquatic toxicity is 82.6 mg/l fish, EC₀ 84 mg/l Daphnia Magna, EC₅₀ 94.5 mg/l Algae. Other preferred sequestrants may be the Dissolvine GL series. Such sequestrants may be Glutamic acid, N,N Diacetic acid and their Tetrasodium salts. These sequestrants are readily biodegradable and are made of renewable raw material. They have an acute oral toxicity of more then 2000 mg/kg and very good aquatic toxicity with an EC₅₀>100 mg/l for Daphnia Magna, algae and fish (rainbow trout). An optional version of this product is manufactured by AKZO/NOBEL functional chemicals, 525 Van Bullen street, Chicago, Ill., USA.

### Builders

The disinfectant cleaner of the present invention also comprises builders chosen from the group consisting of silicates, carbonates and citrates and combinations thereof. Some preferred builders are silicates, carbonates, citrates, and the like. Silicates included pentahydrate metasilicate, anhydrous silicate, potassium and sodium salt. However, if they are used, their amount should not cause a raise in the pH over the permitted threshold of causing corrosiveness or irritation to the skin; if so, the composition will no longer meet the CCD-166 criteria. High levels of silicate can also cause instability with the quaternary ammonium compound(s) and thus should be kept in check. This issue makes the carbonates and the citrates preferred builders for the disinfectant cleaner of the present invention. Sodium carbonate and citrate mixtures is particularly preferred because of its available alkalinity and is relative lack of corrosiveness and safe aquatic toxicity profile and mammalian toxicity which are respectively 347 mg/l for Daphnia Magna(24H), 565 mg/l (96H) and 4,090 mg/kg DL₅₀ oral rat.

### Solvents

In optional embodiments of the disinfectant cleaner of the present invention, there may also be solvents as ingredients that can be useful. Such solvents may be glycol ether. Preferred is propylene glycol cas # 57-55-6 as it can impart to the disinfectant cleaner lower skin irritancy and, if used with citrate builder, improved tackiness for better filming on vertical surfaces. This will improve the contact period of the disinfectant ingredients and assure more adequate disinfection.

Dipropylene glycol methyl ether is another preferred solvent in the disinfectant cleaner, particularly for cleaning and disinfection, considering is versatility at dissolving many types of soils, such like ink, grease, synthetic, minerals and vegetable oils, organic stains, carbon and clays. This solvent also has a high flash point, meets the 10 days window for ready biodegradation, has aquatic acute toxicity of >100 mg/l, passes the DFE screening test and appears on the Cleangredients list. However, its percentage in the disinfectant cleaner of the present invention should be limited to permit one to meet the requirements of CCD-166.

### Other Considerations and Information Regarding the Disinfectant Cleaner

Indeed, “green products” are gaining in popularity as industries, institutions and domestic fields are now demanding their use. The disinfectant cleaner of the present invention provides an ecological, readily biodegradable, and less toxic alternative to what has been done up to now, including the existing certified disinfectant cleaners that have met the CCD-166 criteria. The organic ingredients used in the disinfectant cleaner of the present invention are readily biodegradable. Aquatic, oral and dermal acute toxicity, with improved hard water tolerance and self adherence to surfaces are improvements over what has been done up to now.

The following sets forth some advantages and requirements for various preferred embodiments of the present invention:
The disinfectant cleaner is recognized as an effective cleaner disinfectant for hard surfaces by Health Canada, who has issued a DIN number 02319853, and an equivalent of EPA number in United States of America.
The disinfectant cleaner is a concentrate of 1-80 parts water.
The disinfectant cleaner is not an irritant when diluted and may be preferably used when concentrations are less then 5% by weight as per the OECD 404 test method use by Stepan™ (study 5108 “Treatment with the 0.6% or lower concentration did not cause skin irritation”).
The disinfectant cleaner does not contain volatile organic compounds with the exception of an amount contained in the active disinfectant ingredients, this percentage by weight being less then 0.5% and whose flash point is over 61° C.
The disinfectant cleaner is an energy saver as it can be used with cold water or at room temperature (20° C.).
The disinfectant cleaner does not contain any of the following ingredients recognized to be damaging to ecosystems or users: halogenated solvents, aromatic solvents, prohibited ethylene glycol ethers compounds or its acetates, alkyl phenol ethoxylates (including nonyl phenols octylphenols and their ethoxylates); builders belonging to any of the following groups: phosphates, ethylene diaminetetreaacetic acid, ethylene dinitrilotetraacetic acid, nitrilotriacetic acid and the salts of these compounds.
The disinfectant cleaner does not contain any of the following classes of disinfectant agents: halogens salts, benzalkonium chloride, phenolics, peroxyacetic acids, toxic metals including but not limited to arsenic, cadmium, chromium, lead and mercury compounds.
The % VOC (volatile organic compounds) in the disinfectant cleaner is less then 1% at use dilution (1-80 parts water).
The disinfectant cleaner is free of any chemicals included in the proven list of IARC (International Agency for research on Cancer) group 1 proven group, group 2A probable and group 2B Carcinogen.
The disinfectant cleaner does not contain any fragrance for the purpose only of good smelling.
The disinfectant cleaner does not contain dyes.
The whole disinfectant cleaner composition is not toxic when tested on luminescent bacteria, using report EPS1/RM/24 Nov. 1992 of Environment Canada, ASTM method D5660-96, results demonstrate an IC₅₀ of more then >100 mg/l.
The components of the disinfectant cleaner which are organics are all “Readily Biodegradable”.
Based on its standard use 1 part to 80 parts of water the oral acute toxicity is more than 2,000 mg/kg.
The disinfectant cleaner has been tested successfully for its cleaning efficiency according to method ASTM D-4488-95A5 “Particulate and Oily Soil vinyl tiles”.
The disinfectant cleaner has been tested successfully for cleaning performance on ceramic as bathroom cleaner according to method ASTM D5343.
The disinfectant cleaner has been tested successfully according to method CAN/CGSB-2.161.97 “Assessment of efficacy of Anti-microbial Agents for use on Environmental surfaces and Medical Devices”.
Another improvement of the present invention over prior art is the ability of the disinfectant to perform with higher water hardness tolerance. BTC 818 used in the present invention has been proven to be efficient in hard water up to 800 ppm. Issuance of a PCP number in Canada # 25427 is a proof of this claim. The same observation applies in the United States by issuance of a EPA # 1839-119. Either instance demands data to support all claims before they issued a PCP number (Canada) or EPA number (USA).
Another important consideration is the self adherence of the solution to vertical and horizontal surfaces, due to its tacky nature which provides a uniform coating. This assures improved penetration of the soiling material and more assured disinfection of the total surfaces especially vertical ones. One improved aspect is that embodiments of the solution may be provided in a single coating to meet the 10 minutes contact necessary for proper disinfection (rules of Health Canada and EPA), whereas known cleaners will require a second application to keep the surface wet and achieve a proper disinfection.

The following sets forth some further properties and advantages for various preferred embodiments of the present invention:
The disinfectant cleaner is a composition for an ecological certified cleaner disinfectant under criteria CCD-166 of Terrachoice Environmental Marketing organisation of Canada and USA, based on free benzene quaternary ammonium compounds, non-ionic surfactants, builders, sequestrants and solvents which meet all the requirements described in the CCD-166 criteria.
The disinfectant cleaner is a composition with improved mammalian oral toxicity of 500 mg/kg compared to 450 mg/kg.
The disinfectant cleaner is a composition with improved aquatic acute toxicity of 0.094 mg/l compared to 0.058 mg/l for Daphnia Magna.
The disinfectant cleaner is a composition with improved hard water performance and tolerance of 800 ppm compared to 600 ppm.
The disinfectant cleaner is a composition with improved acute dermal toxicity of 2,000 mg/kg compared to 365 mg/kg.
The disinfectant cleaner is a tacky composition which adheres to vertical and horizontal hard surfaces, improving soils removal and disinfection contact time.
The disinfectant cleaner also enables a cleaning efficiency according to ASTM D4488-95-A5 of at least 85%.

The disinfectant cleaner of the present invention indeed provides a multitude of advantages over what has been done and known up to now.

### EXAMPLES

Examples of some embodiments of the disinfectant cleaner of the present invention are described herein below:

Quaternary ammonium compound(s) are used as disinfecting agents and consist essentially of didecyl dimethyl ammonium chloride or a mixture of octyl decyl dimethyl ammonium chloride 50%, dioctyl dimethyl ammonium chloride 25%, didecyl dimethyl ammonium chloride 25%, sold as BTC 818™ 80% from Stepan™ Company, Northfield, Ill., USA, and are used at a level of 4.8% by weight in the total composition of the disinfectant cleaner.

The preferred non-ionic surfactant is alcohol ethoxylate, sold as Biosoft 25-9™ and Biosoft 91-8™ from Stepan™ Company, Northfield, Ill., USA and Videt Q3™ from Vitech International™, Milton, Wis., USA. They are used at a level of 2 to 7% by weight, preferably at a level of 4 to 6% by weight of total weight of the total composition of the disinfectant cleaner.

The preferred sequestering agents are citrate, glutamic acid, tartaric acid, methyl glycinate, EDDS (ethylene diamine disuccinate) and IDS (iminodisuccinate tetrasodium salt) and salts thereof. The most preferred is iminodisuccinate tetrasodium salt, known as Baypure™ of Lanxess Corporation™, 111 Ridc Park West Drive, Pittsburgh, Pa., USA. It is used at level of 1 to 10% by weight of total composition, most preferably at 1 to 3% by weight of the total composition of the disinfectant cleaner.

The preferred other ingredients of the disinfectant cleaner are builders. The builders are silicate, citrate, carbonate or mixtures thereof. The most preferred builders are a mixture of sodium carbonate and citrates at a level of 2 to 8% by weight of the total composition of the disinfectant cleaner. The most preferred level of sodium carbonate is 2 to 5% by weight of the total composition of the disinfectant cleaner with 2 to 4% of sodium citrate by weight of the total composition of the disinfectant cleaner.

Preferred other ingredients are Glycol Ethers, such as Dipropylene Glycol Methyl Ether or Propylene Glycol Ether or mixtures of thereof. Most preferred is Propylene Glycol Ether at a level of 5 to 10% by weight of the total composition of the disinfectant cleaner, preferably 3 to 7% by weight of the total composition and most preferably 2 to 4% by weight of the composition of the disinfectant cleaner.

Experimentation was conducted on different cleaners to assess them based on ASTM D4488-95-A5 and ASTM D5343-06. The results are shown below:

Results table for ASTM D4488-95-A5

| | | Avg. % cleaning |
|---|---|---|
| Sample | Dilution | efficiency |
| Disinfectant with 5:3:2 proportion of | 80:1 | 60.5 |
| quaternary ammonium chloride. | | |
| Embodiment of present invention with | 80:1 | 90.5 |
| octyl decyl dimethyl ammonium | (600 ppm | |
| chloride, dioctyl dimethyl ammonium | quaternary | |
| chloride and didecyl dimethyl | compounds) | |
| ammonium chloride, in a relative | | |
| proportion of about 2:1:1 by weight, of | | |
| formula A. | | |

The ASTM D4488-95-A5 test shows a surprising improvement with an embodiment of the disinfectant cleaner of the present invention using formula A, over a cleaner using a quaternary ammonium mixture of octyl decyl dimethyl ammonium chloride, didecyl dimethyl ammonium chloride and dioctyl dimethyl ammonium chloride in a proportion of 5:3:2.

Results table for ASTM D5343-06

| | | Avg. % cleaning |
|---|---|---|
| Sample | Dilution | efficiency |
| Disinfectant with 5:3:2 proportion of | 80:1 | 94.6 |
| quaternary ammonium chloride. | | |
| Embodiment of present invention with | 80:1 | 94.4 |
| octyl decyl dimethyl ammonium | (600 ppm | |
| chloride, dioctyl dimethyl ammonium | quaternary | |
| chloride and didecyl dimethyl | compounds) | |
| ammonium chloride, in a relative | | |
| proportion of about 2:1:1 by weight, of | | |
| formula A. | | |

Results table for ASTM D4488-95-A5

| | | Avg. % cleaning |
|---|---|---|
| Sample | Dilution | efficiency |
| Embodiment of present invention with | 80:1 | 85.0 |
| didecyl dimethyl ammonium chloride as | (600 ppm | |
| only quaternary ammonium compound, | quaternary | |
| of formula B. | compounds) | |

The ASTM D4488-95-A5 test shows a surprising improvement with an embodiment of the disinfectant cleaner of the present invention using formula B, over a cleaner using a quaternary ammonium mixture of octyl decyl dimethyl ammonium chloride, didecyl dimethyl ammonium chloride and dioctyl dimethyl ammonium chloride in a proportion of 5:3:2.

Results table for ASTM D5343-06

| | | Avg. % cleaning |
|---|---|---|
| Sample | Dilution | efficiency |
| Embodiment of present invention with | 80:1 | 98.3 |
| didecyl dimethyl ammonium chloride as | (600 ppm | |
| only quaternary ammonium compound, | quaternary | |
| of formula B. | compounds) | |

The ASTM D5343-06 test also shows improved performance of the single didecyl embodiment.

Two exemplary formulas (herein referred to as formulas A and B) of embodiments of the present invention, which achieved an ASTM D4488-95-A5 performance of at least 85% cleaning efficiency, are:

Formula A: Water 83.95%, sodium citrate 1.25%, sodium carbonate 3.00%, sodium iminodisuccinate 2.50%, ethoxylated fatty alcohol 4.50%, BTC 818 4.80% on a basis of 100% active, dilution 1:80.

Formula B: Water 89.18%, sodium citrate 2.25%, sodium iminodisuccinate 2.50%, ethoxylated fatty alcohol 1.125%, propylene glycol 1.875%, dipropylene glycol 1.850%, BTC 1010 1.20% on a basis of 100% active, dilution 1:20.

The above examples of a preferred embodiment of the disinfectant cleaner of the present invention are here given only to better understand the invention and should not be interpreted as limiting. Although the present invention has been described in considerable detail for certain embodiments, such have been presented for the purpose of illustration and not limitation. One skilled in the art will appreciate that the present invention can be practiced by other than the described embodiments and the scope of the invention should not be limited to the description contained herein.

1. A benzeneless quaternary ammonium disinfectant cleaner comprising:
quaternary ammonium compounds either comprising (i) octyl decyl dimethyl ammonium chloride, dioctyl dimethyl ammonium chloride and didecyl dimethyl ammonium chloride, in a relative proportion of about 2:1:1 by weight or (ii) consisting essentially of didecyl dimethyl ammonium chloride;
a sequesterant chosen from polycarboxylates, silicates, carbonates, citrates, diamines, glutamic acids and salts thereof and combinations thereof;
a surfactant; and
a builder chosen from silicates, carbonates and citrates and combinations thereof.

2. The disinfectant cleaner of claim 1, further comprising a solvent chosen from glycol ethers and mixtures thereof.

3. The disinfectant cleaner of claim 2, wherein the solvent comprises propylene glycol.

4. The disinfectant cleaner of claim 3, wherein the solvent comprises dipropylene glycol methyl ether.

5. The disinfectant cleaner of claim 1, wherein the sequesterant is chosen from citrate, gluconate, tartaric, adipic, iminodisuccinate, ethylene diamine disuccinate, glutamic acids and salts thereof, and methyl glycinate.

6. The disinfectant cleaner of claim 1, wherein the surfactant comprises non-ionic surfactants.

7. The disinfectant cleaner of claim 6, wherein the non-ionic surfactants are chosen from linear ethoxylated fatty alcohols, alcohol ethoxylate, alkyl polyglucosides, alkanolamides, lauryl amine oxides, myristyl amine oxides, and coco amine oxides.

8. The disinfectant cleaner of claim 1, wherein the surfactant comprises amphoteric surfactants.

9. The disinfectant cleaner of claim 8, wherein the amphoteric surfactants are chosen from amidopropyl betaine, alkyl amine oxide and amphoteric sultaine.

10. The disinfectant cleaner of claim 1, wherein the builder is chosen from pentahydrate metasilicate, anhydrous silicate, potassium and sodium salt.

11. The disinfectant cleaner of claim 1, wherein the builder is chosen from citrates and carbonates.

12. The disinfectant cleaner of claim 1, wherein the builder is added in an amount to avoiding raise in pH over permitted thresholds of corrosiveness and skin irritation.

13. The disinfectant cleaner of claim 1, wherein the dilution level is about 1:80 parts water.

14. The disinfectant cleaner of claim 1, comprising a maximum of 0.5 wt % volatile organic compounds and having a flash point is over 61° C. of the disinfectant.

15. The disinfectant cleaner of claim 1, presenting mammalian acute toxicity orally and dermally and with regard to aquatic acute toxicity for Daphnia Magna of at least about 0.094 mg/l for EC₅₀.

16. The disinfectant cleaner of claim 1, presenting water hardness acceptability up to 800 ppm of calcium carbonate.

17. The disinfectant cleaner of claim 1, presenting an average cleaning efficiency according to ASTM D4488-95-A5 of at least 85%.

18. The disinfectant cleaner of claim 1, presenting an average cleaning efficiency according to ASTM D5343-06 of at least 94%.

19. The disinfectant cleaner of claim 1, wherein the total concentration of quaternary ammonium compounds is between about 450 ppm and about 1200 ppm at use dilution.

20. The disinfectant cleaner of claim 1, wherein the total concentration of quaternary ammonium compounds is about 600 ppm at use dilution.
